(19) United States
(12) Patent Application Publication
(10) Pub. No.: US 2020/0092670 A1
(43) Pub. Date: Mar. 19, 2020

(54) AUDIO OUTPUT DEVICES

(71) Applicant: HEWLETT-PACKARD DEVELOPMENT COMPANY, L.P., SPRING, TX (US)

(72) Inventors: NATAN FACCHIN, PORTO ALEGRE (BR); JULIA ZOTTIS, PORTO ALEGRE (BR)

(21) Appl. No.: 16/469,640

(22) PCT Filed: Apr. 7, 2017
(86) PCT No.: PCT/US2017/026503

§ 371 Date: Jun. 14, 2019

(51) Int. Cl. H04S 7/00; G06F 3/0481; H04M 1/725; G06F 3/16; H04S 3/00; H04R 5/02; H04R 5/04

(52) U.S. Cl. CPC H04S 7/303; G06F 3/04817; H04M 1/72569; H04M 1/6058; H04S 3/008; H04R 5/02; H04R 5/04; G06F 3/165

(57) ABSTRACT

A mobile computing device includes a first audio output device positioned on a first side of the mobile computing device, a second audio output device positioned on a second side of the mobile computing device opposite the first side, at least one sensor to determine an orientation of the mobile computing device relative to a user, and logic to activate the first audio device and the second audio device based on the position of the mobile computing device relative to the user.

### BACKGROUND

Audio output devices allow users to listen to a wide variety of media, and have become ubiquitous in everyday lives of those users. Audio output devices may produce audible sounds through the use of a type of electrostatic transducer that converts an electrical audio signal into a corresponding sound. These audio output devices may be a stand-alone device such as external speakers, or may be embedded or included as part of an electronic device such as internal speakers within a computing device.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a mobile computing device, according to an example of the principles described herein.

FIG. 2 is a block diagram of a system including the mobile computing device of FIG. 1, according to an example of the principles described herein.

FIG. 3 is a block diagram of a system including the mobile computing device of FIG. 1, according to another example of the principles described herein.

FIG. 4 is a diagram of a front side and a back side of a mobile computing device, according to an example of the principles described herein.

FIG. 5 is a diagram of a network of electronic devices, according to an example of the principles described herein.

FIG. 6 is a circuit diagram of a front audio device amplifier and a rear audio device amplifier of the mobile computing device of FIG. 3, according to an example of the principles described herein.

FIGS. 7 and 8 are diagrams of a graphic user interface (GUI) for communicatively coupling a number of audio output devices within a network, according to an example of the principles described herein.

FIG. 9 is a flowchart showing a method of controlling a number of audio output devices, according to an example of the principles described herein.

FIG. 10 is a flowchart showing a method of controlling a number of audio output devices; according to another example of the principles described herein.

Throughout the drawings; identical reference numbers designate similar, but not necessarily identical, elements. The figures are not necessarily to scale, and the size of some parts may be exaggerated to more clearly illustrate the example shown. Moreover; the drawings provide examples and/or implementations consistent with the description; however, the description is not limited to the examples and/or implementations provided in the drawings.

### DETAILED DESCRIPTION

Audio output devices allow users to listen to media such as spoken word or musical media. In one example, an audio output device may be a stand-alone device such as external speakers that may communicatively couple to an electronic device. In this example, the electronic device coupled to the speakers sends audio signals such as audio data to the speakers. In another example, the audio output device may be embedded or included as part of an electronic device such as in the form of internal speakers within a computing device. In this example, audio signals such as audio data may be sent by a processing device common between the internal speakers and the computing device.

A standard as to audio output device location and orientation within computing devices such as laptop computing devices, smartphones, tablet computing devices, gaming computing devices, and other mobile computing devices do not exist. For example, some of these computing devices include front-facing speakers that deliver sound in the direction of a user as the user interacts with a user interface such as, for example, a touch screen display. Other computing devices include back-facing speakers that deliver sound in a direction opposite of a user as the user interacts with a user interface, Still other computing devices may include two audio output devices on the on the front of the computing device.

In some situations, the computing devices may be positioned or oriented such that at least one audio output device is unable to acoustically deliver its produced sound to the user in an effective manner or at all. For example, a user may lay a smartphone that includes a front-facing audio output device and a back-facing audio output device on one side or the other so that the front-facing audio output device and a back-facing audio output device are not effective. In this scenario, the computing device may be programmed to deliver one channel of audio such as a left channel to the front-facing audio output device and a second channel such as a right channel to a back-facing audio output device in order to provide a surround sound experience. However, with one of the front-facing audio output device and the back-facing audio output device being ineffective due to it abutting a surface, the surround sound intended to be produced by the front-facing and back-facing audio output devices, the entire audio output experience is not had by the user.

Further, in other situations, the computing device may utilize audio output devices of other computing devices and stand-alone audio output devices. This may allow a master computing device to communicatively couple to a number of slave audio output devices of other computing devices and stand-alone audio output device. However, in many examples, the master computing device may find it difficult to create an effective surround sound experience for the user given the unknown position and orientation of the slave audio output devices of other computing devices and stand-alone audio output device. For example, other users controlling the slave devices such as smartphones and tablet computing devices may be interacting with their individual devices while the master is communicating with the slave devices, and may be repositioning and reorienting the slave devices such that the potential for an effective surround sound experience for the users may be diminished.

Examples described herein provide a mobile computing device. The mobile computing device may include a first audio output device electrically coupled to the mobile computing device and positioned on a first side of the mobile computing device, a second audio output device electrically coupled to the mobile computing device and positioned on a second side of the mobile computing device opposite the first side, at least one sensor to determine an orientation of the mobile computing device relative to a user, and logic to activate the first audio device or the second audio device based on the position of the user relative to the mobile computing device.

The mobile computing device may further include an auxiliary audio output detector to detect at least one auxiliary audio output device external to the mobile computing device. In this example, the mobile computing device may include logic to communicatively couple the mobile computing device to the auxiliary audio output device, and logic to cause the auxiliary audio output device to output a different channel of audio different from the first audio output device and the second audio output device. Logic to activate at least one of the auxiliary audio output devices based on a signal sent by the mobile computing device may also be included. Further, the mobile computing device may include logic to determine a spatial location of the auxiliary audio output device relative to the mobile computing device.

Logic to display a graphical user interface (GUI) on the mobile computing device may also be included. The GUI may present a number of user-selectable icons which, when selected, effect the activation of the first audio output device, the second audio output device, the auxiliary audio output device, or combinations thereof.

Examples described herein also provide a system for controlling a number of audio output devices. The system may include a mobile computing device. The mobile computing device may include a first audio output device controlled by and positioned on a first side of the mobile computing device, a second audio output device controlled by and positioned on a second side of the mobile computing device opposite the first side, at least one sensor to determine a position of a user relative to the mobile computing device, logic to activate either the first audio device or the second audio device based on the position of the user relative to the mobile computing device, and an auxiliary audio output detector to detect a number of auxiliary audio output devices external to the mobile computing device.

The system may further include logic to communicatively couple the mobile computing device to the auxiliary audio output devices, and logic to cause the auxiliary audio output devices to output a different channel of audio different from the first audio output device and the second audio output device. In one example, the sensor may include a photodetector located on the first side of the mobile computing device. In response to a determination that the photodetector detects electromagnetic energy, the mobile computing device may deactivate the second audio output device. Further, in response to a determination that the photodetector does not detect electromagnetic energy, the mobile computing device may deactivate the first audio output device.

The auxiliary audio output devices external to the mobile computing device may include a number of audio output devices of another mobile computing device. The mobile computing device sends a number of audio packets defining a number of audio channels to the auxiliary audio output devices external to the mobile computing device based on a longitudinal and latitudinal positions of the auxiliary audio output devices relative to the mobile computing device.

Examples described herein also provide a computer program product for controlling a number of audio output devices. The computer program product may include a non-transitory computer readable storage medium including computer usable program code embodied therewith. The computer usable program code, when executed by a processor may determine an orientation of a mobile computing device based on data obtained from a number of sensors of the mobile computing device. The orientation of the mobile computing device may include exposing a first side of the mobile computing device to a user and exposing a second side of the mobile computing device to the user. In response to a determination that the data indicates that the mobile computing device is oriented to expose the first side of the mobile computing device, a first audio output device located on the first side of the mobile computing device is activated, and a second audio output device located on the second side of the mobile computing device is deactivated.

The computer program product may further include computer usable program code to, when executed by the processor, activate the second audio output device located on the second side of the mobile computing device and deactivate the first audio output device located on the first side of the mobile computing device in response to a determination that the data indicates that the mobile computing device is oriented to expose the second side of the mobile computing device.

The computer program product may further include computer usable program code to, when executed by the processor, detect a number of auxiliary audio output devices external to the mobile computing device. The computer program product may further include computer usable program code to, when executed by the processor, communicatively couple the mobile computing device to the auxiliary audio output devices, determine spatial locations of the auxiliary audio output devices relative to the mobile computing device, send a number of audio packets defining a number of audio channels to the auxiliary audio output devices based on the spatial locations of the auxiliary audio output devices relative to the mobile computing device.

As used in the present specification and in the appended claims, the term “audio output device” or similar language is meant to be understood broadly as any electroacoustic transducer which converts an electrical audio signal into a corresponding sound. In one example, an audio output device may include speakers, speakers within an electronic device, speakers within a computing device, and other types of electroacoustic transducers located as stand-alone devices or as part of another electrical device.

Additionally, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

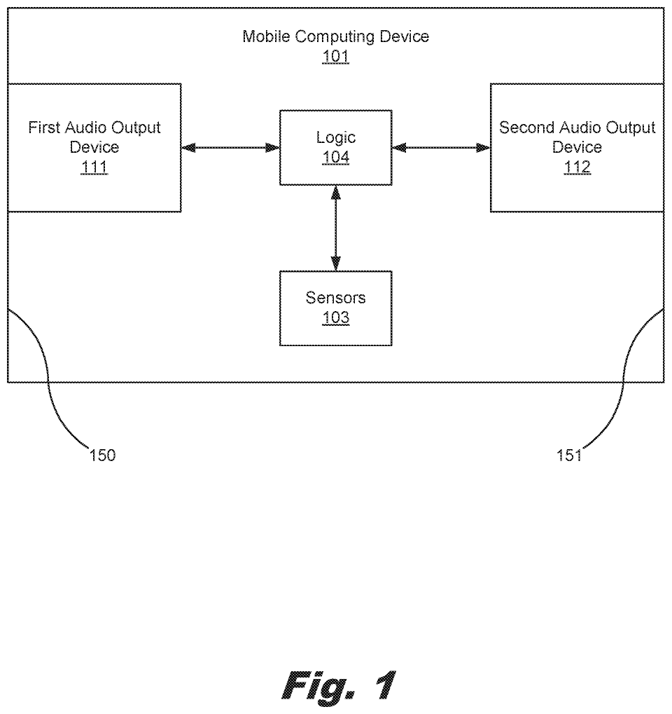

Turning now to the figures, FIG. 1 is a block diagram of a mobile computing device (101), according to an example of the principles described herein. The mobile computing device (101) may be any computing device that may be repositioned or reoriented through a user repositioning or reorienting the mobile computing device (101). Examples of the mobile computing device (101) may include a laptop computing device, a smartphone, a mobile phone, a tablet computing device, a wearable computing device, a personal digital assistant (FDA), portable audio output devices, other mobile computing devices, and combinations thereof.

The mobile computing device (101) may include a first audio output device (111) electrically coupled a mobile computing device and positioned on a first side (150) of the mobile computing device (101). The mobile computing device (101) may also include a second audio output device (112) electrically coupled to the mobile computing device (101) and positioned on a second side (151) of the mobile computing device (101) opposite the first side (150).

At least one sensor (103) may be included within the mobile computing device (101). In one example, the sensor (103) may include any number of devices used to determine the movement, position, acceleration, and orientation, of the mobile computing device (101), determine a user's interaction with the mobile computing device (101), or combinations thereof. In one example, the sensor may include an accelerometer to determine the proper acceleration of the mobile computing device (101), a gyroscope to measure the orientation of the mobile computing device (101), a photodetector to detect a level of electromagnetic radiation to which at least one side of the mobile computing device (101) is exposed, a touch sensor to detect a touch of a user touching at least a portion of the mobile computing device (101), other sensing devices, and combinations thereof.

The mobile computing device (101) may also include logic (104) to activate the first audio device (111) or the second audio device (112) based on the position of the mobile computing device (101) relative to the user. The logic (104) may activate the first audio device (111), the second audio device (112), or a combination thereof.

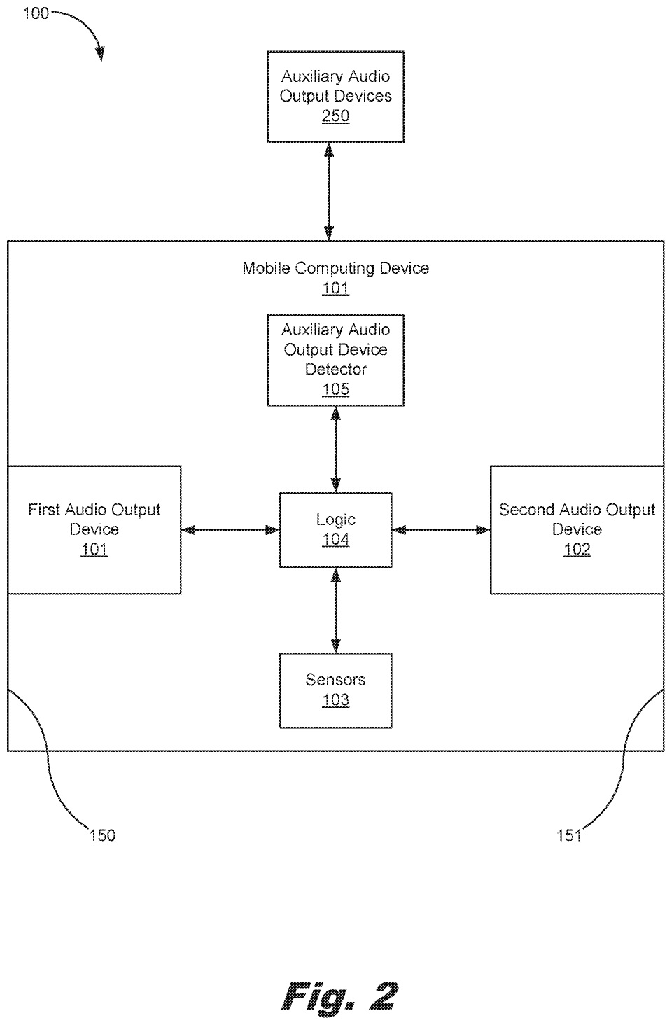

FIG. 2 is a block diagram of a system (100) including the mobile computing device (101) of FIG. 1, according to an example of the principles described herein. Those elements similarly numbered in FIG. 2 relative to FIG. 1 are described above in connection with FIG. 1 and other portions herein. The mobile computing device (101) within the system (100) may include an auxiliary audio output device detector (105) to detect a number of output audio devices that are located outside the mobile computing device (101). In one example, the auxiliary audio output device detector (105) may use any communication protocol to broadcast to other devices within an area to detect a number of auxiliary audio output devices (250) to allow the auxiliary audio output devices (250) to detect the mobile computing device (101). In another example, the auxiliary audio output device detector (105) may detect any communication protocol broadcast sent from a number of auxiliary audio output devices (250) within the area of the mobile computing device (101).

The mobile computing device (101) and the auxiliary audio output devices (250) may use any handshaking process and protocol for negotiating communications between all the devices (101, 250) and dynamically setting parameters of a communications channel established between the mobile computing device (101) and the auxiliary audio output devices (250). Further, the mobile computing device (101) and the auxiliary audio output devices (250) may use any communication protocol to communicate with and send data between one another. Examples of communication protocols may include, for example, any IEEE 802.llx communication protocol, a Wi-Fi communication protocol, a Bluetooth wireless technology standard, a near-field communication (NFC) communication protocol, other communication protocols, and combinations thereof.

The mobile computing device (101) creates a master-slave relationship with a number of the auxiliary audio output devices (250). A master-slave communication relationship is a model of communication where one device has unidirectional control over a number of other devices. In the system (100) of FIG. 2, the mobile computing device (101) is selected as the master, and the auxiliary audio output devices (250) act in the role of slaves. In one example, a number of the auxiliary audio output devices (250) may acts as masters to other auxiliary audio output devices (250) that act as slaves. In this example, the mobile computing device (101) may send signals and data to the auxiliary audio output devices (250) including, for example, handshake requests, data packets including audio and video data, data relating to an identity of the mobile computing device (101) and auxiliary audio output devices (250), other forms of data, and combinations thereof.

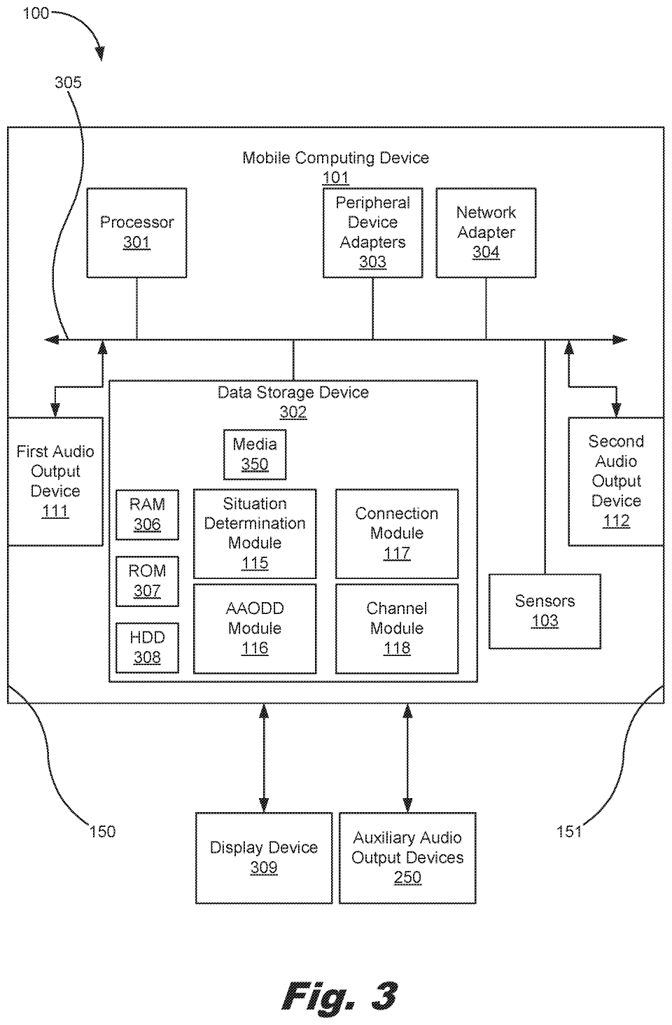

FIG. 3 is a block diagram of a system (100) including the mobile computing device (101) of FIG. 1, according to another example of the principles described herein. The system (100) may be utilized in any data processing scenario including, stand-alone hardware, mobile applications, through a computing network, or combinations thereof. Further, the system (100) may be used in a computing network, a public cloud network, a private cloud network, a hybrid cloud network, other forms of networks, or combinations thereof. In one example, the methods provided by the system (100) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the system (100) are executed by a local administrator.

To achieve its desired functionality, within the system (100), the mobile computing device (101) may include various hardware components. Among these hardware components may be a number of processors (301), a number of data storage devices (302), a number of peripheral device adapters (303), and a number of network adapters (304). These hardware components may be interconnected through the use of a number of busses and/or network connections. In one example, the processor (301), data storage device (302), peripheral device adapters (303), and network adapter (304) may be communicatively coupled via a bus (305).

The processor (301) may include the hardware architecture to retrieve executable code from the data storage device (302) and execute the executable code. The executable code may, when executed by the processor (301), cause the processor (301) to implement at least the functionality of determine an orientation of a mobile computing device (101) based on data obtained from a number of sensors (103) of the mobile computing device (101).

The processor (301) may also implement at least the functionality of activating a first audio output device (111) located on the first side (150) of the mobile computing device (101) and deactivate a second audio output device (112) located on the second side (151) of the mobile computing device (101) in response to a determination that the data indicates that the mobile computing device (101) is oriented to expose the first side (150) of the mobile computing device (101). The processor (301) may also implement at least the functionality of activating the second audio output device (112) located on the second side (151) of the mobile computing device (101) and deactivate the first audio output device (111) located on the first side (150) of the mobile computing device (101) in response to a determination that the data indicates that the mobile computing device (101) is oriented to expose the second side (151) of the mobile computing device (101).

The processor (301) may also implement at least the functionality of detecting a number of auxiliary audio output devices (250) external to the mobile computing device (101). Further, the processor (301) may also implement the functionality of communicatively coupling the mobile computing device (101) to the auxiliary audio output devices (250), determining spatial locations of the auxiliary audio output devices (250) relative to the mobile computing device (101), and sending a number of audio packets defining a number of audio channels to the auxiliary audio output devices (250) based on the spatial locations of the auxiliary audio output devices (250) relative to the mobile computing device (101).

Still further, the processor (301) may also implement the functionality of outputting a different channel of audio different from the first audio output device (111) and the second audio output device (112) to the auxiliary audio output devices (250). At least one of the auxiliary audio output devices (250) may be activated based on a signal sent by the mobile computing device (101). The processor (301) may also implement the functionality of determining a spatial location of the auxiliary audio output devices (250) relative to the mobile computing device (101). Even still further, the processor (301) may also implement the functionality of displaying a graphical user interface (GUI) on the mobile computing device (101) where the GUI presents a number of user-selectable icons which, when selected, effect the activation of the first audio output device (111), the second audio output device (112), the auxiliary audio output devices (250), or combinations thereof. The processor (301) may also implement other functionalities according to the methods of the present specification described herein. In the course of executing code, the processor (301) may receive input from and provide output to a number of the remaining hardware units.

The data storage device (302) may store data such as executable program code that is executed by the processor (301) or other processing device. The data storage device (302) may store computer code representing a number of applications that the processor (301) executes to implement at least the functionality described herein. The data storage device (302) may include various types of memory modules, including volatile and nonvolatile memory. For example, the data storage device (302) of the present example includes Random Access Memory (RAM) (306), Read Only Memory (ROM) (307), and Hard Disk Drive (HDD) memory (308). Many other types of memory may also be utilized, and the present specification contemplates the use of many varying type(s) of memory in the data storage device (302) as may suit a particular application of the principles described herein. In certain examples, different types of memory in the data storage device (302) may be used for different data storage needs. For example, in certain examples the processor (301) may boot from Read Only Memory (ROM) (307), maintain nonvolatile storage in the Hard Disk Drive (HDD) memory (308), and execute program code stored in Random Access Memory (RAM) (306).

The data storage device (302) may comprise a computer readable medium, a computer readable storage medium, or a non-transitory computer readable medium, among others. For example, the data storage device (302) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (303, 304) in the mobile computing device (101) enable the processor (301) to interface with various other hardware elements, external and internal to the mobile computing device (101). For example, the peripheral device adapters (303) may provide an interface to input/output devices, such as, for example, display device (309), a mouse, or a keyboard. The peripheral device adapters (303) may also provide access to other external devices such as an external storage device, a number of network devices such as, for example, servers, switches, and routers, client devices, other types of computing devices, and combinations thereof.

The display device (309) may be internal to or a separate device communicatively coupled to the mobile computing device (101). The display device (309) may allow a user of the system (100) to interact with and implement the functionality of the mobile computing device (101). The peripheral device adapters (303) may also create an interface between the processor (301) and the display device (309), a printer, or other media output devices. The network adapter (304) may provide an interface to other computing devices within, for example, a network, thereby enabling the transmission of data between the mobile computing device (101) and other devices located within the network such as, for example, the auxiliary audio output devices (250).

The mobile computing device (101) may, when executed by the processor (301), display the number of graphical user interfaces (GUIs) on the display device (309) associated with the executable program code representing the number of applications stored on the data storage device (302). The GUIs may include aspects of the executable code including, for example, the automatic and manual selection of the auxiliary audio output devices (250) as described herein. The GUIs may display, for example, a number of auxiliary audio output devices (250) communicatively coupled to the mobile computing device (101). Additionally, via making a number of interactive gestures on the GUIs of the display device (309), a user may cause the mobile computing device (101) to automatically select auxiliary audio output devices (250) to which the mobile computing device (101) will serve as a master device, may cause the mobile computing device (101) to establish or disconnect communication with the auxiliary audio output devices (250), or combinations thereof. Examples of display devices (309) include a computer screen, a laptop screen, a mobile device screen, a personal digital assistant (FDA) screen, and a tablet screen, among other display devices (309). Examples of the GUIs displayed on the display device (309), will be described in more detail below.

The mobile computing device (101) may further include a number of modules used in the implementation of the functionality of the mobile computing device (101) described herein. The various modules within the mobile computing device (101) include executable program code that may be executed separately. In this example, the various modules may be stored as separate computer program products. In another example, the various modules within the mobile computing device (101) may be combined within a number of computer program products; each computer program product comprising a number of the modules.

The mobile computing device (101) may include a situation determination module (115) to determine the movement, position, acceleration, orientation, of the mobile computing device (101), a user's interaction with the mobile computing device (101), or combinations thereof. The sensors (103) may provide data regarding the movement, position, acceleration, and orientation of the mobile computing device (101), or combinations thereof to the processor (301) and other elements of the mobile computing device (101). The processor (301) may utilize that data to determine the output of audio for the audio output devices (111, 112) within the mobile computing device (101).

In one example, the sensors (103) may include a photodetector located on the first side (150) of the mobile computing device (101). In this example, the second audio output device (112) may be deactivated by the processor (301) in response to a determination that the photodetector detects electromagnetic energy. In other words, the second audio output device (112) may be deactivated of the photodetector detects light. This is indicative of the mobile computing device (101) lying face up on a substrate like a table, for example. In contrast, in response to a determination that the photodetector does not detect the electromagnetic energy, the processor (301) may deactivate the first audio output device (111) since this is indicative of the mobile computing device (101) lying face down on a substrate like the table so that the first side (150) abuts the surface.

In another example, the sensors (103) may further include a display device detector to detect whether a display device (309) of the mobile computing device (101) is turned on or off. In this example, the processor (301), executing the situation determination module (115), may determine that the front side (150) of the mobile computing device (101) is abutting the surface and is face down on the surface if the photodetector detects no electromagnetic radiation and the display device (309) of the mobile computing device (101) is turned off. In this situation, the processor (103) may deactivate the first audio output device (111) located on the front side (150) of the mobile computing device (101). Conversely, if the photodetector detects some electromagnetic radiation and the screen is turned on, the processor (301), executing the situation determination module (115), may determine that the back side (151) of the mobile computing device (101) is abutting the surface and is face up on the surface. In this situation, the processor (103) may deactivate the second audio output device (112) located on the back side (151) of the mobile computing device (101). An example of computer usable program code of the situation determination module (115) executed by the processor (301) may be as follows:

```
import os
import sys
luminance = 0.1
screenPowerOn = True
shouldUseSensor = True
frontSpeakers = True
backSpeakers = False
if shouldUseSensor:
              if luminance > 0.01 and screenPowerOn:
                      frontSpeakers = True
                      backSpeakers = False
                      print “Turn on front speakers”
              else:
                      frontSpeakers = False
                      backSpeakers = True
                      print “Turn on back speakers”
else:
              #frontSpeakers = readConfig(“frontSpeakers”)
              #backSpeakers = readConfig(“backSpeakers”)
              print “Set speakers according to user preferences”
```

In the above example of computer usable code, the luminance threshold for detection by the photodetector as a sensor (103) is 0.01, Further, the above example of computer usable code allows for the user to set user preferences of the activation of the first (111) and second (112) audio output devices, and override the photodetection and screen power detection in the “if shouldUseSensor” statement through the second “else” statement.

In another example, the sensors (103) may include a number of accelerometers to determine the proper acceleration of the mobile computing device (101), and a number of gyroscopes to measure the orientation of the mobile computing device (101). Through the data obtained from these sensors (103), the mobile computing device (101) may determine whether it is face up, face down, or standing upright and not abutting any surface to determine whether to deactivate the second audio output device (112), the first audio output device (111) or neither the second (112) or first (111) audio output device, respectively.

The situation determination module (115) may also be used to determine the movement, position, acceleration, and orientation of the auxiliary audio output devices (250) relative to the mobile computing device (101). In one example, the movement, position, acceleration, orientation, of the auxiliary audio output devices (250) relative to the mobile computing device (101) may be detected by a number of corresponding sensors within the auxiliary audio output devices (250), and the relay of data collected from those sensors to the mobile computing device (101). This data collected from the auxiliary audio output devices (250) may be used to best determine which channels of audio data are sent to which of the auxiliary audio output devices (250) to provide a user and other individuals listening to the media (350) produced by the mobile computing device (101) and auxiliary audio output devices (250). In this example, the mobile computing device (101) may request the data from the auxiliary audio output devices (250) and/or the auxiliary audio output devices (250) may send the data to the mobile computing device (101). In determining what channels of audio to send to the auxiliary audio output devices (250), the mobile computing device (101) may request for and consider data representing the longitudinal and latitudinal positions of the auxiliary audio output devices (250) relative to the mobile computing device (101). This longitudinal and latitudinal positions of the auxiliary audio output devices (250) relative to the mobile computing device (101) may be determined through the use of accelerometers, gyroscopes, global positioning systems (GPS) devices, or other devices that may detect and define the location and position of the auxiliary audio output devices (250) relative to the mobile computing device (101). In surround sound environments, the placement of audio output devices influences the effectiveness of the sound. Use of these types of sensors and their respective data allows the mobile computing device (101) to determine which audio channel to send to which auxiliary audio output device (250) to create a most effective surround sound environment.

The mobile computing device (101) may also include an auxiliary audio output device detection (AAODD) module (116) to, when executed by the processor (301), allow the mobile computing device (101) to detect a number of auxiliary audio output devices (250) connectable to the mobile computing device (101). Any number of auxiliary audio output devices (250) may be detected by the AAODD module (116), and either automatically or manually selected to be communicatively coupled to the mobile computing device (101). A connection module (117) may also be included within the mobile computing device (101) to initiate communications between the auxiliary audio output devices (250) and the mobile computing device (101), and transfer signals and date between the auxiliary audio output devices (250) and the mobile computing device (101). The connection module (117) may communicatively couple the mobile computing device (101) to the auxiliary audio output devices (250) automatically or as instructed and manually selected by the user via a GUI. The connection module (117) may also communicatively disconnect a number of the auxiliary audio output devices (250) from the mobile computing device (101) automatically or as instructed and manually selected by the user via the GUI.

The mobile computing device (101) may include a channel module (118) to determine which of a number of audio channels within media to send to the first audio output device (111), the second audio output device (112), the auxiliary audio output devices (250), and combinations thereof. For example, the channel module (118) may determine the number of channels within the media to be output through the first audio output device (111), the second audio output device (112), the auxiliary audio output devices (250), and combinations thereof. The media may include a plurality of channels that form a surround sound experience, and in which each channel may be sent to individual audio output devices to create the surround sound environment. Surround sound is a technique for enriching the sound reproduction quality of an audio source with additional audio channels from speakers that surround the listener, a provided a more immersive sound as opposed to sounds that emanate from a single source. The channel module (118) may consider a number of parameters when determining the most effective and suitable distribution of the channels of the media including the movement, position, acceleration, and orientation, and may consider these aspects of the mobile computing device (101), the auxiliary audio output devices (250), or combinations thereof, and may consider a number of users' interactions with the mobile computing device (101) and/or the auxiliary audio output devices (250), or combinations of these parameters.

The channel module (118) may also consider the type and functionality of each of the first audio device (111), the second audio device (112), the auxiliary audio output devices (250) in considering which channel of the audio to send to which of the first audio device (111), the second audio device (112), or the auxiliary audio output devices (250). For example, one of the auxiliary audio output devices (250) may include a woofer audio output device designed to produce relatively lower frequency sounds, and the first audio device (111), the second audio device (112), or another of the auxiliary audio output devices (250) may include a treble speaker designed to produce relatively higher audio frequency sounds. In this manner, the capabilities associated with the first audio device (111), the second audio device (112), and the auxiliary audio output devices (250) may be used by the channel module (118) to determine which channel of the media (350) is sent to which audio output device.

The channel module (118) may also consider the type of surround sound specification associated with the media (350). Examples of types of surround sound may include an ambisonic specification, a sonic whole overhead specification, monoaural specification, a biarural specification, a 5.1 surround sound specification, a 7.1 surround sound specification, a 10.2 surround sound specification, an 11.1 surround sound specification, a 22.2 surround sound specification, other surround sound specifications, and combinations thereof. These surround sound specifications include a number of channels that may be assigned or mapped to the first audio device (111), the second audio device (112), the auxiliary audio output devices (250) individually or in groups. For example, in a situation where five audio output devices are included among the first audio device (111), the second audio device (112), and the auxiliary audio output devices (250), and the media (350) to be produced through those audio output devices includes a 5.1 surround sound specification, then data representing the different channels may be sent out to the five audio output devices. Further, data representing the low-frequency effects (LFE) channel designated by the “0.1” in the 5.1 surround sound specification may be transmitted to one of the audio output devices that is already receiving one of the channels. In this manner, an audio output device may receive more than one channel, and the plurality of channels received by that audio output device may be output by that audio output device.

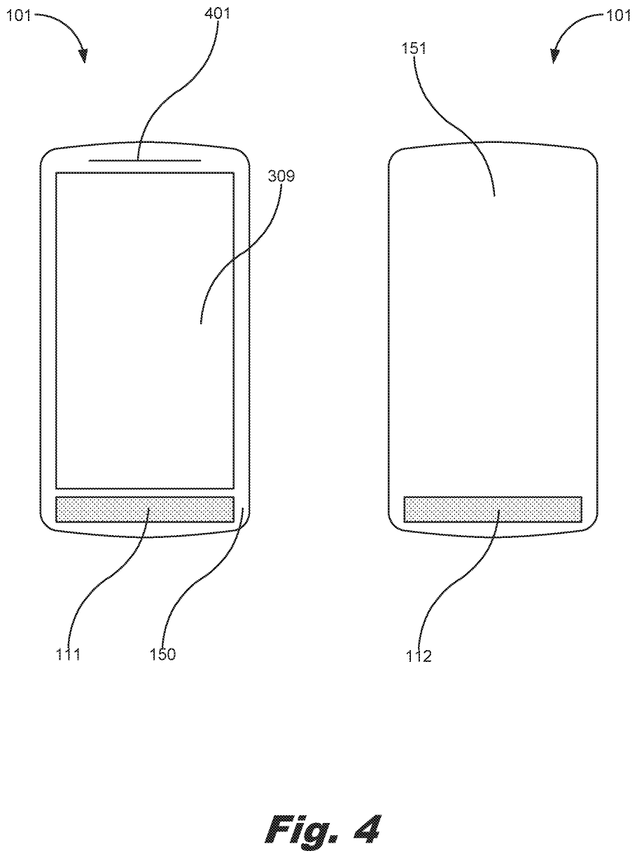

FIG. 4 is a diagram of a front side (150) and a back side (151) of a mobile computing device (101), according to an example of the principles described herein. In one example, the mobile computing device (101) may include a display device (309). In one example, the display device (309) is a user-interactive touch screen. Further, in one example, the display device (309) may display a number of GUIs associated with the functionality of the processor (301) described herein.

The mobile computing device (101) may also include the first audio output device (111) located on the front side (150) of the mobile computing device (101), and a second audio output device (112) located on a back side (151) of the mobile computing device. In one example, the mobile computing device (101) may be positioned or oriented such that the front side (150) or the back side (151) is abutting a surface such that the first (111) or second (112) audio output device is unable to acoustically deliver its produced sound to the user in an effective manner or at all. For example, a user may lay the mobile computing device (101) down on a table or other surface such that the front-facing first audio output device (111) is abutting the surface. In this scenario, the processor (301) of the mobile computing device (101) utilizes the situation determination module (115) and the sensors (103) to determine the movement, position, acceleration, orientation, of the mobile computing device (101). If it is determined that the mobile computing device (101) is lying on a surface with the first or front side (150) exposed and the second or back side (151) abutting the surface, the processor (301) may turn off the second audio output device (112) located on the back side (151) and rely on the first audio output device (111) to output the audio. In one example, the processor (301) may instruct the first audio output device (111) to output one channel of audio of the media (350) such as a left channel to the front-facing audio output device. However, in another example, the processor (301) may instruct the first audio output device (111) to output all channels defined by the media (350).

The mobile computing device (101) may also include a third audio output device (401) located on the front side (150) of the mobile computing device (101). In one example, a third audio output device (401) may be used as an earpiece during the execution of a telephone call. In another example, however, the third audio output device (401) may be used as second front-facing audio output device that is used in connection with the first audio output device (111). In this example, with the second audio output device (112) being ineffective due to it abutting a surface, the processor (301) may deactivate the second audio output device (112) and instruct the first audio output device (111) and the third audio output device (401) to divide the channels of audio defined by the media (350). In this example, the first audio output device (111) may output at least one channel of audio, and the third audio output device (401) may deliver at least one channel of audio. In this manner, the most effective and auditorily pleasing output may be received by the user.

In another example, the front side (150) of the mobile computing device (101) may be abutting the surface and unable to effectively output audio from the first audio output device (111) and the third audio output device (401). In this example, the processor (301) may deactivate the first audio output device (111) and the third audio output device (401), and may instruct the second audio output device (112) to output a number of the channels of the audio defined by the media (350).

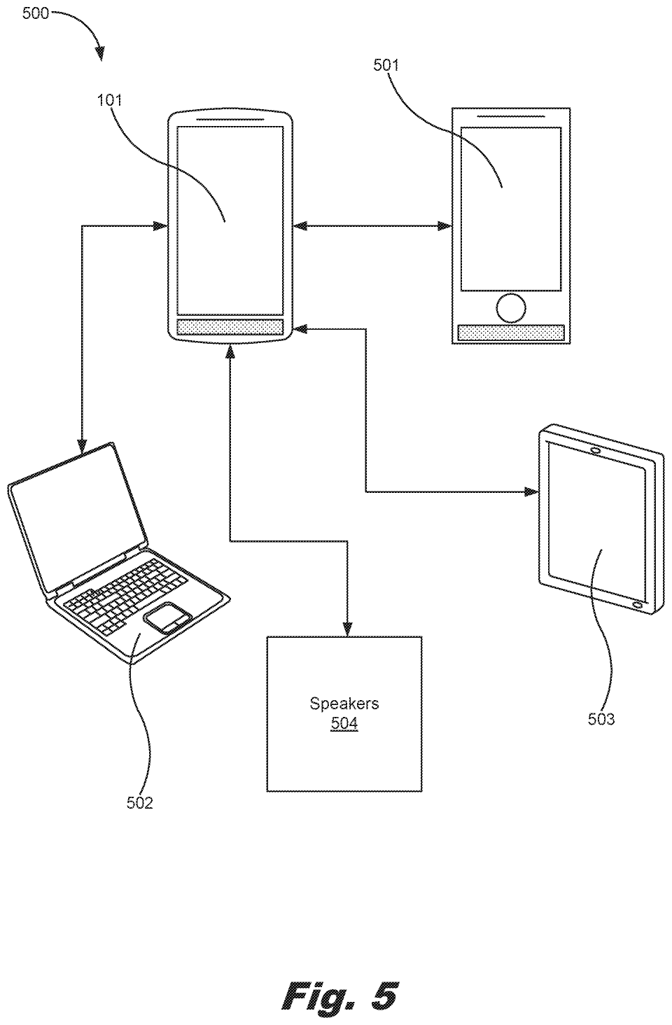

FIG. 5 is a diagram of a network (500) of electronic devices (101, 501, 502, 503, 504), according to an example of the principles described herein. The electronic devices may include a smart phone (101, 501), a laptop computing device (502), a tablet computing device (503), and a number of auxiliary speakers (504). The smart phone (501), laptop computing device (502), and tablet computing device (503), may include audio output devices, and may include functionality similar to the mobile computing device (101). Any type of audio output device may be included within the network (500) of electronic devices (101, 501, 502, 503, 504). Each of these devices (101, 501, 502, 503, 504) may be discoverable devices such that they may broadcast their availability and connectability to one another and the mobile computing device (101). The processor (301) of the mobile computing device (101) may utilize the AAODD module (116) to detect a number of auxiliary audio output devices (250) including the electronic devices (501, 502, 503, 504) as described herein.

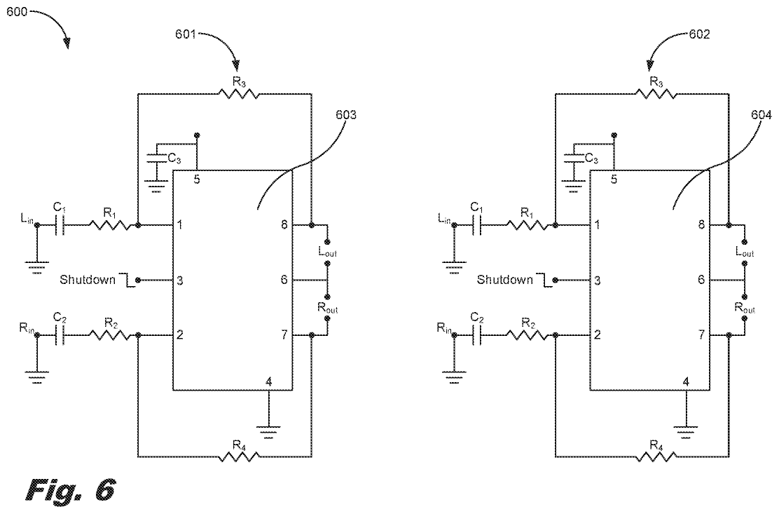

FIG. 6 is a circuit diagram (600) of a front audio device amplifier (601) and a rear audio device amplifier (602) of the mobile computing device (101) of FIG. 3, according to an example of the principles described herein. With reference to FIGS. 3 and 4, when the processor (301) of the mobile computing device (101) utilizes the situation determination module (115) and the sensors (103) to determine the movement, position, acceleration, orientation, of the mobile computing device (101), the processor (301) may deactivating at least one of the audio output devices (111, 112) by turning of a corresponding one of the front audio device amplifier (601) or rear audio device amplifier (602).

The amplifier circuits (601, 602) may include a number of integrated circuits (603, 604), a number of capacitors (C₁, C₂, C₃), a number of resistors (R₁, R₂, R₃, R₄), a shutdown pin (shutdown), a left channel output (Lₒᵤₜ), and a right channel output (Rₒᵤₜ). The amplifier circuits (601, 602) may be shut down or deactivated by applying a signal to the shutdown pin (Shutdown) as instructed by the processor (301).

Further, the processor (301) may instruct the first amplifier circuit (601) to output the left channel by selecting left channel output (Lₒᵤₜ) at pins 6 and 8, and may instruct the second amplifier circuit (602) to output the right channel by selecting the right channel output (Rₒᵤₜ) at pins 6 and 7. In this manner, the amplifier circuits (601, 602) may create a surround sound environment for the user.

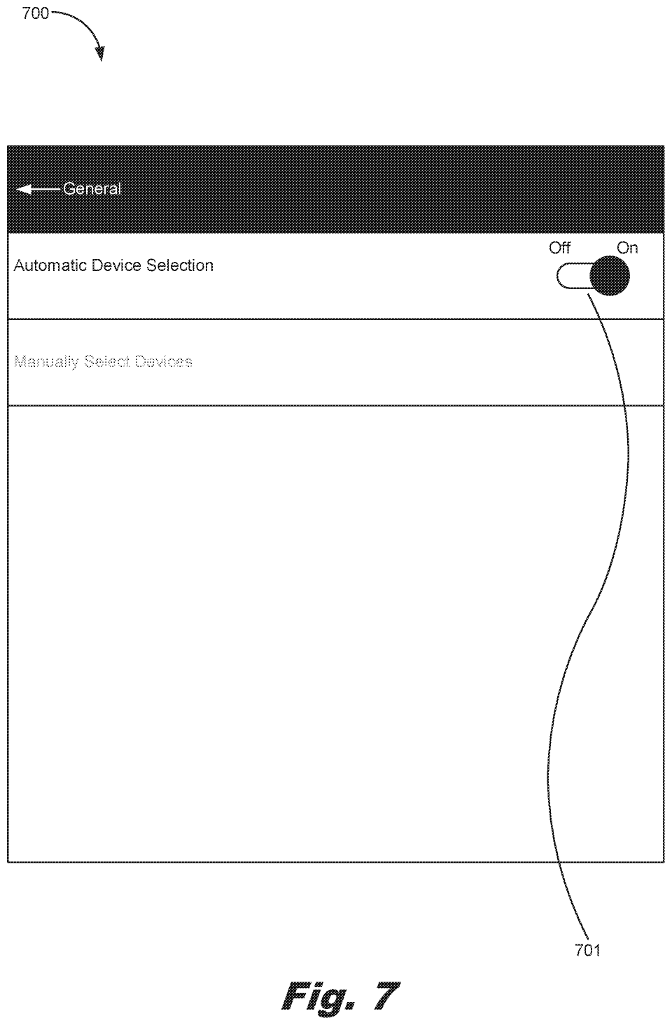

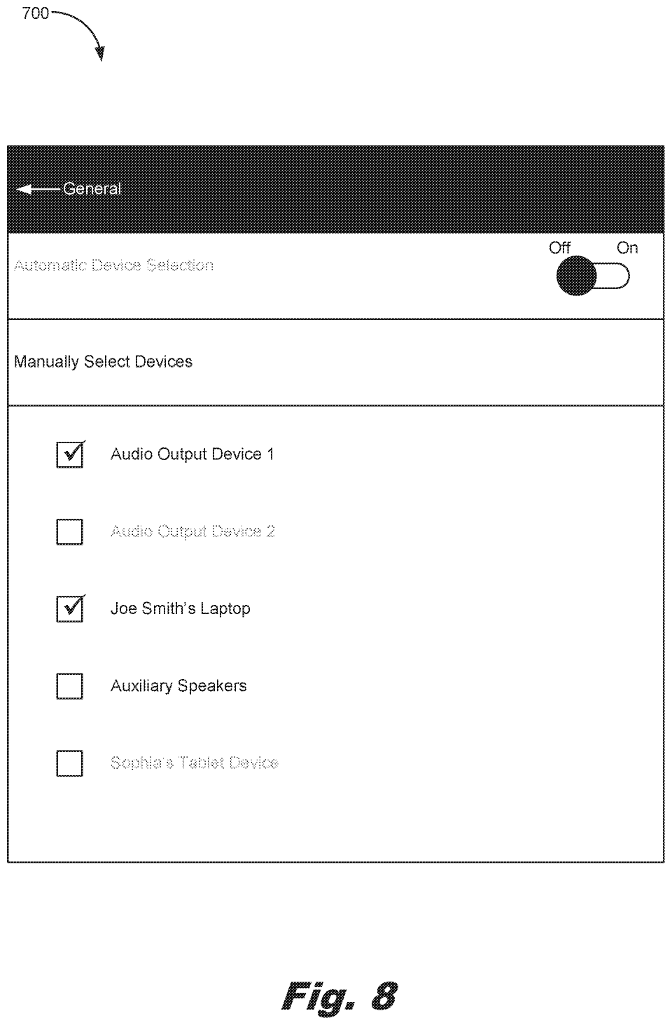

FIGS. 7 and 8 are diagrams of a graphic user interface (GUI) (700) for communicatively coupling a number of audio output devices (101, 111, 112, 501, 502, 503, 504) within a network (500), according to an example of the principles described herein. The GUI (700) may be presented to a user when accessing settings associated with the mobile computing device (101). The GUI (700) may include a toggle (701) to, when activated, allow a user to select automatic device detection or manual device detection and selection. In FIG. 7, the toggle (701) of the GUI (700) is selected to “ON” to provide for automatic device selection. In this state, the mobile computing device (101) may choose which audio output devices (101, 111, 112, 501, 502, 503, 504) within the network (500) to couple to using the AAODD module (116) to detect a number of auxiliary audio output devices (250) connectable to the mobile computing device (101). The connection module (117) may initiate communications between the audio output devices (111, 112, 501, 502, 503, 504) within a network (500) and the mobile computing device (101), and transfer signals and date between the audio output devices (111, 112, 501, 502, 503, 504) and the mobile computing device (101). The processor (301) may then execute the channel module (118) to determine which of a number of audio channels within media (350) to send to the audio output devices (111, 112, 501, 502, 503, 504) and the first (111) and second (112) audio output devices of the mobile computing device (101).

In FIG. 8, the toggle (701) of the GUI (700) is selected to “OFF” to provide for manual device selection. In this state, the mobile computing device (101) may deactivate the automatic device selection field, and present in the GUI (700) a list of audio output devices a user may select from to create a communication channel with and send data to. In the example of FIG. 8, the list may include “Audio Output Device 1,” “Audio Output Device 2,” a laptop computing device identified as “Joe Smith's Laptop,” “Auxiliary Speakers,” and a tablet computing device identified as “Sophia's Tablet Device.” The user may select any of those devices available for selection in the list. In the example of FIG. 8, the user has selected the first audio output device (111) of the mobile computing device (101) as indicated by the check. The user has also selected Joe Smith's Laptop as another device to send audio data.

The second audio output device (112) of the mobile computing device (101) is included in the list, but is listed in ghost and is unselectable. In this example, the mobile computing device (101) has determined, via execution of the situation determination module (115), that the second audio output device (112) would not be an effective audio output device based on the movement, position, acceleration, or orientation of the mobile computing device (101). Thus, the option for the second audio output device (112), while being detected through the execution of the AAODD module (116), is not available.

The auxiliary speakers were not selected by the user, but are indicated as being a selectable audio output device since the AAODD module (116) discovered them. Further, the tablet computing device identified as “Sophia's Tablet Device” is indicated as being detected through the execution of the AAODD module (116), but not available and is indicated as such since it is displayed in ghost. The reason for the tablet computing device's unavailability as a discovered but unselectable audio output device may include, for example, the owner of the tablet computing device rejecting such a request. Another reason for the tablet computing device's unavailability as a discovered but unselectable audio output device may include, for example, the distance between the tablet computing device and the mobile computing device (101). In this example, the tablet computing device may have once been within range of a communicative coupling with the mobile computing device (101), but has since moved out of range.

The user may select a number of the audio output devices available in the list of devices in FIG. 8, and the processor (301) may adjust the distribution of data including data defining a number of channels of audio within the media (350) to the audio output devices available in the list. Further, as one device becomes unavailable, or additional devices become available, the mobile computing device (101) may automatically couple to or decouple from the mobile computing device (101), or may present those devices as available or not available for selection by a user as presented in FIGS. 7 and 8. In this manner, the devices discovered through execution of the AAODD module (116) may be dynamically assigned or unassigned channels of audio from the media (350) based on their availability within the network (500).

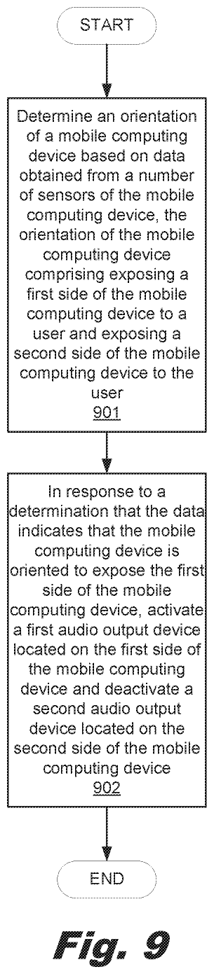

FIG. 9 is a flowchart showing a method of controlling a number of audio output devices (111, 112, 401), according to an example of the principles described herein. The method of FIG. 9 may include determining (block 901) an orientation of a mobile computing device (101) based on data obtained from a number of sensors (103) of the mobile computing device (101). Block 901 may be performed by the processor (301) executing the situation determination module (115) and the collection of data from the sensors (103). The orientation of the mobile computing device (101) may include exposing a first side (150) of the mobile computing device (101) to a user or exposing a second side (151) of the mobile computing device (101) to the user. As described herein, the mobile computing device (101) may be positioned or oriented such that the front side (150) or the back side (151) is unable to acoustically deliver its produced sound to the user in an effective manner or at all. For example, a user may lay the mobile computing device (101) down on a table or other surface such that the front-facing first audio output device (111) is abutting the surface. In another example, the user may have one side (150, 151) of the mobile computing device (101) directed toward him or herself, causing the audio produced by the audio output device (111, 112) facing away from the user to be less effective.

The method of FIG. 9 may further include activating (block 902) a first audio output device (111) located on the first side (150) of the mobile computing device (101), and deactivating a second audio output device (112) located on the second side (151) of the mobile computing device (101) in response to a determination that the data obtained from the sensors (103) indicates that the mobile computing device (101) is oriented to expose the first side (150) of the mobile computing device (101). In this manner, the mobile computing device (101) may determine which of the audio output devices (111, 112, 401) should be used to provide an output of the media (350) to the user.

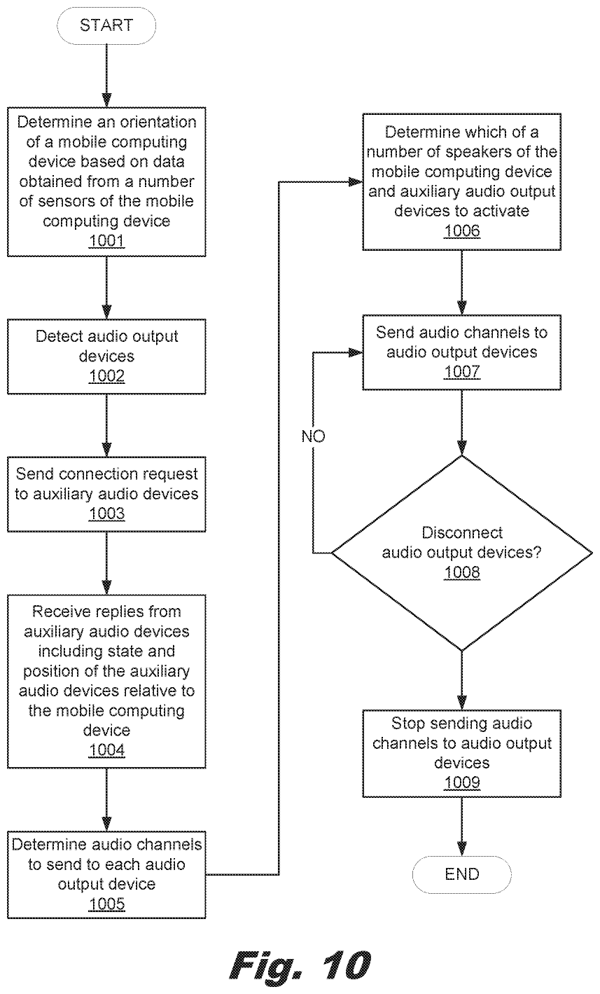

FIG. 10 is a flowchart showing a method of controlling a number of audio output devices (111, 112, 401, 501, 502, 503, 504), according to another example of the principles described herein. The method may include determining (block 1001), with the processor (301) executing the situation determination module (115), an orientation of the mobile computing device (101) based on data obtained from a number of sensors (103) of the mobile computing device (101). The processor (301) executing the AAODD module (116), may detect (block 1002) a number of audio output devices (111, 112, 401, 501, 502, 503, 504) including those within the mobile computing device (101) such as audio output devices (111, 112, 401) and those auxiliary to the mobile computing device (101) such as the electronic devices (501, 502, 503, 504).

A connection request may be sent (block 1003) by the processor (301) executing the connection module (117) to the audio output devices (111, 112, 401, 501, 502, 503, 504) in response to a detection of the audio output devices (111, 112, 401, 501, 502, 503, 504) made by the AAODD module (116) as executed by the processor (301). A number of replies from auxiliary audio devices may be received (block 1004) by the mobile computing device (101) including a state and position of the auxiliary audio devices (111, 112, 401, 501, 502, 503, 504) relative to the mobile computing device (101).

The processor (103) of the mobile computing device (101) may execute the channel module (118) to determine (block 1005) which audio channels to send to each audio output device (111, 112, 401, 501, 502, 503, 504). Executing the situation determination module (115) and the channel module (118), the processor (301) may determine (block 1006) which of a number of audio output devices such as speakers (111, 112, 401) of the mobile computing device (101) and auxiliary audio output devices (501, 502, 503, 504) to activate. The audio channels of the media (350) are sent (block (1007) to the audio output devices (111, 112, 401, 501, 502, 503, 504) as determined by execution of the channel module (118) by the processor (301).

After data representing the audio channels of the media (350) is sent to the audio output devices (111, 112, 401, 501, 502, 503, 504), a determination (block 1008) may be made as to whether or not to disconnect the audio output devices (111, 112, 401, 501, 502, 503, 504). If it is determined that data representing the audio channels of the media (350) is to continue to be sent to the audio output devices (111, 112, 401, 501, 502, 503, 504) (block 1008, determination NO), then the method may loop back to block 1007, and the data may continue to be sent to the audio output devices (111, 112, 401, 501, 502, 503, 504) (block 1007). If it is determined that data representing the audio channels of the media (350) is to not continue to be sent to the audio output devices (111, 112, 401, 501, 502, 503, 504) and the audio output devices (111, 112, 401, 501, 502, 503, 504) are to be disconnected (block 1008, determination YES), then the computing device (1009) may stop sending (block 1009) the audio channels to the audio output devices (111, 112, 401, 501, 502, 503, 504), and the method may terminate.

The examples described herein may also include the sending of data representing video along with the audio channels. In this example, the video may be displayed on display devices of the audio output devices (101, 501, 502, 503, 504) like the display device (309) of the mobile computing device (101).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (301) of the mobile computing device (101) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a mobile computing device. The mobile computing device includes a first audio output device positioned on a first side of the mobile computing device, a second audio output device positioned on a second side of the mobile computing device opposite the first side, at least one sensor to determine an orientation of the mobile computing device relative to a user, and logic to activate the first audio device and the second audio device based on the position of the mobile computing device relative to the user.

The mobile computing device allows for switching between different audio output devices such as speakers according to the position of the mobile computing device, reducing power requirements and sound leaks, and improving sound quality to an overall better multimedia experience. The mobile computing device also combines multiple auxiliary computing devices to create an array of devices, creating stereo or surround sound effect without user configuration or unnecessary cables.

The preceding description has been presented to illustrate and describe examples of the principles described. This description is not intended to be exhaustive or to limit these principles to any precise form disclosed. Many modifications and variations are possible in light of the above teaching.

What is claimed is:

1. A mobile computing device, comprising:
a first audio output device positioned on a first side of the mobile computing device;
a second audio output device positioned on a second side of the mobile computing device opposite the first side;
at least one sensor to determine an orientation of the mobile computing device relative to a user; and
logic to activate the first audio device and the second audio device based on the position of the mobile computing device relative to the user.

2. The mobile computing device of claim 1, comprising an auxiliary audio output detector to detect at least one auxiliary audio output device external to the mobile computing device.

3. The mobile computing device of claim 2, comprising:
logic to communicatively couple the mobile computing device to the auxiliary audio output device; and
logic to cause the auxiliary audio output device to output a different channel of audio different from the first audio output device and the second audio output device.

4. The mobile computing device of claim 3, further comprising logic to activate at least one of the auxiliary audio output devices based on a signal sent by the mobile computing device.

5. The mobile computing device of claim 3, comprising logic to determine a spatial location of the auxiliary audio output device relative to the mobile computing device.

6. The mobile computing device of claim 3, comprising logic to display a graphical user interface (GUI) on the mobile computing device, the GUI presenting a number of user-selectable icons which, when selected, effect the activation of the first audio output device, the second audio output device, the auxiliary audio output device, or combinations thereof.

7. A system for controlling a number of audio output devices, comprising:
a mobile computing device comprising:
a first audio output device controlled by and positioned on a first side of the mobile computing device;
a second audio output device controlled by and positioned on a second side of the mobile computing device opposite the first side;
at least one sensor to determine a position of a user relative to the mobile computing device; and
logic to activate either the first audio device or the second audio device based on the position of the mobile computing device relative to the user; and
an auxiliary audio output detector to detect a number of auxiliary audio output devices external to the mobile computing device.

8. The system of claim 7, comprising:
logic to communicatively couple the mobile computing device to the auxiliary audio output devices; and
logic to cause the auxiliary audio output devices to output a different channel of audio different from the first audio output device and the second audio output device.

9. The system of claim 7, wherein the sensor comprises a photodetector located on the first side of the mobile computing device, and wherein:
in response to a determination that the photodetector detects electromagnetic energy, deactivating the second audio output device, and
in response to a determination that the photodetector does not detect electromagnetic energy, deactivating the first audio output device.

10. The system of claim 9, wherein the auxiliary audio output devices external to the mobile computing device comprises a number of audio output devices of another mobile computing device.

11. The system of claim 7, wherein the mobile computing device sends a number of audio packets defining a number of audio channels to the auxiliary audio output devices external to the mobile computing device based on a longitudinal and latitudinal positions of the auxiliary audio output devices relative to the mobile computing device.

12. A computer program product for controlling a number of audio output devices, the computer program product comprising:
a non-transitory computer readable storage medium comprising computer usable program code embodied therewith, the computer usable program code to, when executed by a processor:
determine an orientation of a mobile computing device based on data obtained from a number of sensors of the mobile computing device, the orientation of the mobile computing device comprising exposing a first side of the mobile computing device to a user and exposing a second side of the mobile computing device to the user; and
in response to a determination that the data indicates that the mobile computing device is oriented to expose the first side of the mobile computing device, activate a first audio output device located on the first side of the mobile computing device and deactivate a second audio output device located on the second side of the mobile computing device.

13. The computer program product of claim 12, comprising computer usable program code to, when executed by the processor activate the second audio output device located on the second side of the mobile computing device and deactivate the first audio output device located on the first side of the mobile computing device in response to a determination that the data indicates that the mobile computing device is oriented to expose the second side of the mobile computing device.

14. The computer program product of claim 12, comprising computer usable program code to, when executed by the processor, detect a number of auxiliary audio output devices external to the mobile computing device.

15. The computer program product of claim 14, comprising computer usable program code to:
communicatively couple the mobile computing device to the auxiliary audio output devices;
determine spatial locations of the auxiliary audio output devices relative to the mobile computing device; and
send a number of audio packets defining a number of audio channels to the auxiliary audio output devices based on the spatial locations of the auxiliary audio output devices relative to the mobile computing device.
